(19) United States
(12) Patent Application Publication
(10) Pub. No.: US 2004/0003961 A1
(43) Pub. Date: Jan. 8, 2004

(54) LOW FREQUENCY HORN

(75) Inventor: David W. Gunness, Sutton, MA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Mackie Designs Inc.

(21) Appl. No.: 10/190,773

(22) Filed: Jul. 5, 2002

(51) Int. Cl. G10K 11/00

(52) U.S. Cl. 181/189; 181/187

(57) ABSTRACT

A low frequency horn apparatus including a throat (20), barrel (30) and mouth (40). The barrel (30) includes a series of chambers (50 and 60) wherein the cross-sectional area of each chamber in the series increases linearly from one end of the chamber to the other. The rate of linear increase is greatest in the first chamber 50 in the series. The chambers are in communication with one another so that sound waves entering the throat aperture (20) of the first chamber (50) in the series travel though each chamber in the series and exit the series of chambers through the mouth (40) of the last chamber (60) in the series. Sounds waves may be created by an electroacoustic transducer (70) that includes a cone. Further, the cross-sectional area of the mouth (40) may be less than the cross-sectional area of the cone (78).

### FIELD OF THE INVENTION

The present invention relates to low frequency horn apparatuses, and more particularly to low frequency folded horn apparatuses.

### BACKGROUND OF THE INVENTION

Most modern electroacoustic sound reproduction requires three separate horns, high frequency, midrange frequency, and low frequency. Each horn includes at least one source of sound waves to load the horn with sound waves. In many loudspeakers, the source of sound waves is an electroacoustic transducer that converts an electronic signal into vibrations. The vibrations vibrate the column of air in front of the electroacoustic transducer projecting the sound waves into the throat, through the barrel, and out the mouth of the horn. The cross-sectional area of many high frequency, midrange frequency, and low frequency horns increases exponentially from the throat to the mouth of the horn.

Many modern loudspeaker designs attempt to reduce the physical space and cost required to reproduce sound by including all three horns within a single loudspeaker device. However, all three horns are not of equal size. Generally, the low frequency horn requires the most physical space because of two design constraints commonly applied to low frequency horns. The first constraint requires that the length of the air column contained within the horn must be at least one quarter of the lowest frequency wavelength reproduced. Further, the cross-sectional area along the air column of such a horn generally increases exponentially from the throat to the mouth. The second conventional constraint requires that the mouth of the horn must be sufficiently large to properly load the horn. Typically, the cross-sectional area of the mouth is at least three to twenty times larger than the cross-sectional area of the cone of the electroacoustic transducer.

For example, a low frequency horn designed to reproduce a 50 Hz signal would be approximately three feet by three feet at the mouth and at least 68 inches long. The cone driver would need to be at least 18 inches in diameter with approximately six cubic feet of air behind it. The aforementioned horn occupies a total of approximately 18 cubic feet and has an enclosure volume greater than 24 cubic feet.

To reduce the space requirement of the low frequency horn, many conventional low frequency horns are designed in a folded configuration. Folded horns require that the horn is bent or folded such that the sound waves must travel around at least one bend. Bending or folding the horn allows the sound waves to traverse a greater distance in a smaller space. Bending the horn, however, does not reduce the overall length of the air column or the size of the throat required to produce the desired sound.

While the conventional approach works well in terms of acoustic power output, it results in very large speaker stacks when used in multiples. The large physical size makes maintaining audience coverage difficult because directivity increases as the size of the acoustic source increases. Large speakers are also more costly to transport and may obstruct the view of audience members.

To avoid obstructing the audience's view of the stage, loudspeakers are often elevated or hung over the heads of the audience. Such speaker arrangements are referred to as “flown” speaker systems. The physical size of low frequency horns significantly lower than 80 Hz has precluded their use in a full-range flown speaker system.

Consequently, a need exists for compact low frequency horn designs as well as for compact speaker designs.

### SUMMARY OF THE INVENTION

The present invention provides a low frequency horn apparatus including a throat, barrel, and mouth. The throat is an aperture through which sound waves may enter the barrel of the low frequency horn apparatus and the mouth is an opening though which sound waves may exit the barrel. The barrel of the low frequency horn apparatus includes a series of chambers each having a cross-sectional area that increases linearly from one end of the chamber to the other. The first chamber in the series having the greatest rate of linear increase in cross-sectional area. Each chamber in the series includes two apertures, an entrance aperture into which sound waves may enter the chamber and a mouth out of which sound waves may exit the chamber. The series of chambers are coupled serially so that the entrance aperture of each chamber after the first chamber is adjacent to the mouth of the chamber preceding it in the series. In this manner, the chambers are in communication with one another so that sound waves that enter the entrance aperture of the first chamber in the series, travel though each chamber in the series, and exit the series of chambers through the mouth of the last chamber in the series. Therefore, the throat of the low frequency horn apparatus is the entrance aperture in the first chamber in the series and the mouth of the low frequency horn apparatus is the mouth of the last chamber in the series.

In a further aspect, the barrel of the low frequency horn apparatus includes two chambers. The first chamber includes the throat of the low frequency horn apparatus and is coupled to the second chamber that includes the mouth of the low frequency horn apparatus. At the location where the chambers are coupled, an opening allows communication between the chambers. The cross-sectional area of both chambers increases linearly from one end of the chamber to another. The rate of increase of the cross-sectional area of the first chamber may be greater than the rate of increase of the cross-sectional area of the second chamber. Furthermore, the source of sound waves used to load the low frequency horn apparatus may include an electroacoustic transducer. The electroacoustic transducer may include a cone and the cross-sectional area of that cone may be larger than the cross-sectional area of the mouth of the low frequency horn apparatus.

Loudspeaker apparatuses constructed to include the low frequency horn apparatuses constructed in accordance with the low frequency horn apparatus invention represent further aspects of the present invention. Such loudspeaker apparatuses include a speaker housing containing at least one low frequency horn apparatus constructed in accordance with the low frequency horn apparatus invention, at least one high frequency horn apparatus, and at least one midrange horn apparatus.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view from a point located from the back and bottom of an embodiment of the low frequency horn apparatus;

FIG. 2 is a cross-sectional view of a cone-type electroacousic transducer known in the art;

FIG. 3 is an isometric view from a point located at the back and bottom of an alternate embodiment of the low frequency horn apparatus;

FIG. 4 is an isometric view from a point located at the front and top of a loudspeaker containing a pair of low frequency horns constructed in accordance with the present invention;

FIG. 5 is a view from the top of a loudspeaker containing a pair of low frequency horns constructed in accordance with the present invention;

FIG. 6 is a view from the front of a loudspeaker containing a pair of low frequency horns constructed in accordance with the present invention; and

FIG. 7 is an isometric view from a point located at the front and top of an alternate embodiment of a loudspeaker containing a pair of low frequency horns constructed in accordance with the present invention.

### DETAILED DESCRIPTION OF THE PREFERRED EMBODIMENT

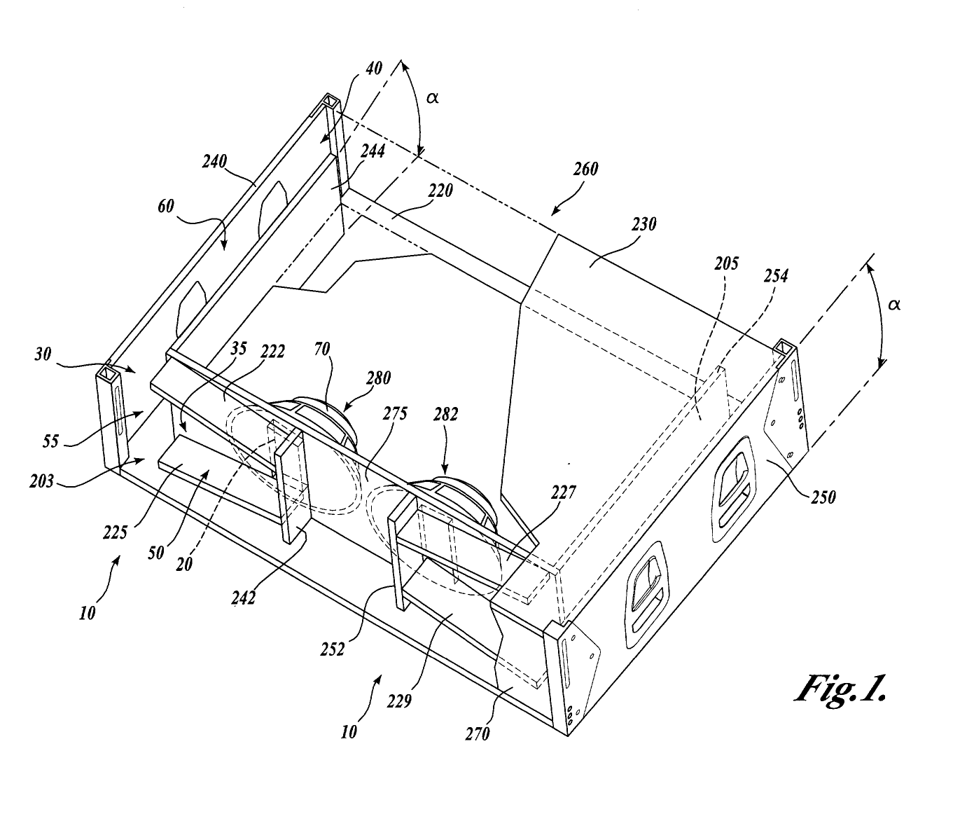

FIG. 1 illustrates a pair of low frequency horns 10 constructed in accordance with an embodiment of the present invention and located on the opposite sides of enclosure. Because each of the horns 10 in FIG. 1 is essentially identical to the other in form and function, only one of the horns will be described in detail. The low frequency horn 10 located on the left side of FIG. 1 has been chosen for illustrative purposes.

Low frequency horn 10 includes a throat 20, barrel 30, and mouth 40. The throat 20 is an aperture in the barrel 30 through which sound waves may enter the low frequency horn 10. The mouth 40 is an aperture in the barrel 30 through which sound waves may exit the low frequency horn 10. Therefore, when sound waves are projected into the throat 20, the sound waves travel through the barrel 30 and exit the low frequency horn 10 through the mouth 40. Preferably, these sound waves may have a frequency from 30 to 200 Hz. However, the length of the barrel may be adjusted to produce a different frequency range.

The source of sound waves is positioned to be approximately adjacent to the throat 20 so that the sound waves produced will enter the barrel 30 of the low frequency horn 10. Sound waves may be produced by any method but, in one preferred embodiment, sound waves are generated by an electroacoustic transducer.

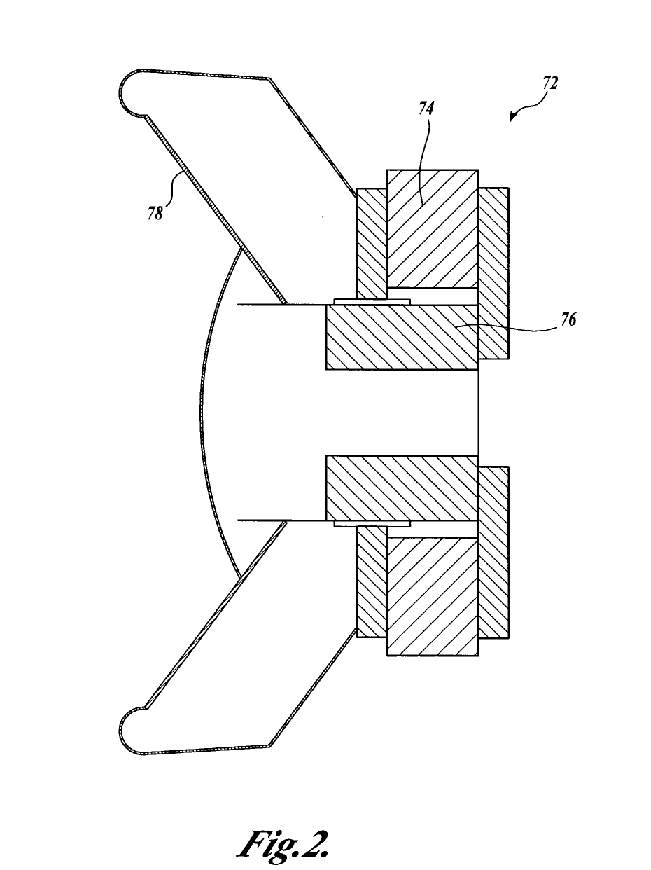

FIG. 1 illustrates an electroacoustic transducer 70 as known in the art. While a type of electroacoustic transducer is depicted in this application for illustrative purposes, it should be apparent that other types of electroacoustic transducers may be substituted for the ones depicted and are also within the scope of the claimed invention. Each electroacoustic transducer converts electronic signals into sound waves. In one embodiment of the present invention, cone-type electroacoustic transducers 72 (depicted in FIG. 2) that utilize a motor 76 with an electromagnet 74 to vibrate a diaphragm or cone 78 may be used to project sound waves into the throat 20 of the low frequency horn 10. The exemplary cone-type electroacoustic transducer depicted in FIG. 2 is well known in the art. The diameter of cone-type electroacoustic transducers 72 is measured at the opening of the cone 78. Preferably, the electroacoustic transducers each have a diameter between about 6 and 18 inches. In the preferred embodiment, 12-inch cone-type electroacoustic transducers may be used.

In one preferred embodiment of the present invention, the cross-sectional area of the mouth 40 of the low frequency horn 10 is less than the cross-sectional area of the cone 78 of the electroacoustic transducer 70. For example, if 12-inch cone-type electroacoustic transducers are used, the cross-sectional area of the cone of the type electroacoustic transducer is approximately 80 inches square. The mouth 40 may have a cross-sectional area between 8 inches square and 80 inches square, and is preferably 18 inches square. In one embodiment, the cross-sectional area of the mouth 40 may be the same as the cross-sectional area of the cone 78. In another embodiment, the cross-sectional area of the mouth 40 may be up to five times smaller than the cross-sectional area of the cone 78.

The barrel 30 of the low frequency horn 10 may include a series of chambers. Adjacent chambers in the series are connected to one another. At the location of the connection between adjacent chambers, an opening between the adjacent chambers is present to allow sound waves to travel between the chambers. In this manner, adjacent chambers in the series are in communication with one another.

In one non-limiting example, the present invention may include a first chamber 50 and a second chamber 60. The first chamber 50 may contain the throat 20 of the low frequency horn 10 and the second chamber 60 may contain the mouth 40 of the low frequency horn 10.

As a non-limiting example best viewed in FIG. 1, the first chamber may be formed between sections of the internal baffle 275, back panel 270, lower diagonal baffle 222, upper diagonal baffle 225, and vertical baffle 242. Furthermore, the throat 20 may be located in internal baffle 275. The source of the sound waves, for example, an electroacoustic transducer 70, may be attached to the surface of the internal baffle 275 opposite the surface forming a portion of the first chamber 50. The first chamber 50 may have a length of from 6 inches to 60 inches, and preferably about 17 inches. The height of the chamber may range from 3 inches to 18 inches, and preferably about 13 inches. The width of the first chamber 50 may range from about 1 inch to 18 inches, and preferably about 3.75 inches. The dimensions are chosen to produce a desirable progression in cross-sectional area through the horn.

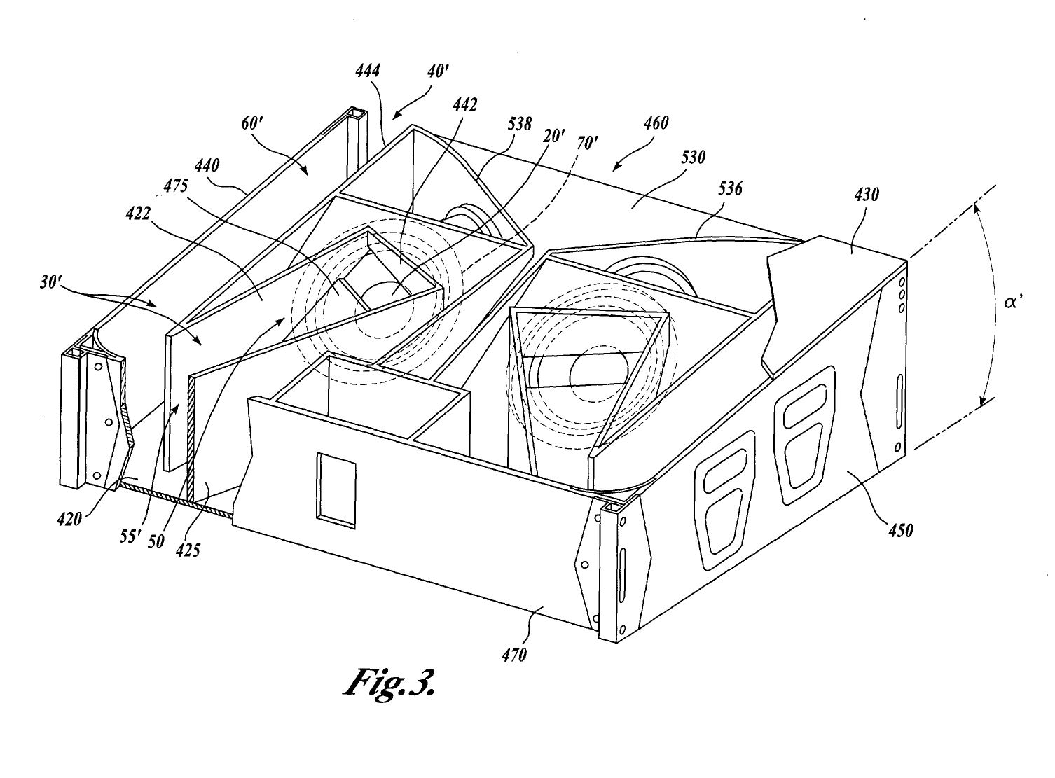

In an alternate embodiment best viewed in FIG. 3, the first chamber 50′ may be formed between sections of a bottom panel 430, an angled side baffle 422, angled side baffle 425, and end baffle 442, and inclined baffle 475. Furthermore, the throat 20′ may be located in inclined baffle 475. The source of the sound waves, for example, an electroacoustic transducer 70′, may be attached to the surface of the inclined baffle 475 opposite the surface forming a portion of the first chamber 50′. The first chamber 50′ may have a length from about 6 inches to 60 inches, and preferably about 17 inches. The height of the chamber may range from 3 inches to 18 inches, and preferably about 13 inches. The width of the first chamber 50′ may range from about 1 inch to 18 inches, and preferably about 3.75 inches.

A non-limiting example of the second chamber 60 is illustrated in FIG. 1. The second chamber 60 may be formed between a portion of a bottom panel 230, a back panel 270, a left exterior side panel 240, top panel 220, and left internal baffle 244 spaced inwardly from the left exterior side panel 240. The second chamber 60 may have a length from about 6 inches to 72 inches, and preferably about 30 inches. The height of the second chamber 60 may range from about 3 inches to 60 inches, and preferably, about 13 inches. The width of the second chamber 60 may range from about 1 inch to 36 inches, and preferably about 3.75 inches. The dimensions are chosen to obtain a desirable progression in cross-sectional area through the horn.

The mouth 40 may be formed by not closing the section of the second chamber 60 formed by the bottom panel 230, left exterior side panel 240, top panel 220, and left internal baffle 244 located nearest the front 260. In a preferred embodiment, the cross-sectional area of the mouth 40 may range from about 8 square inches to about 2000 square inches and is preferably about 48 square inches.

In an alternate embodiment best viewed in FIG. 3, the second chamber 60′ may be constructed in substantially the same manner as the second chamber 60 in FIG. 1. The second chamber 60′ in the embodiment depicted in FIG. 3 may be formed between a portion of a bottom panel 430, a back panel 470, a left exterior side panel 440, top panel 420, and left internal baffle 444. The mouth 40′ may be formed by not closing the section of the second chamber 60′ formed by the bottom panel 430, left exterior side panel 440, top panel 420, and left internal baffle 444 located nearest the front 460.

While in FIG. 1 the cross-sectional shape of both the first 50 and the second 60 chambers are generally rectangular, it is apparent to one of ordinary skill in the art that most other closed shapes, such as round, oval, square, triangular, and trapezoidal, may be functionally equivalent and within the scope of the present invention. Furthermore, the cross-sectional shape of the first chamber 50 need not be identical to the cross-sectional shape of the second chamber 60. For example, as can be seen in FIG. 3, a trapezoidal-shaped first chamber 50′ could be connected to a rectangular-shaped second chamber 60′. Furthermore, as also depicted in FIG. 3, a chamber may change shape from one end to the other end. In FIG. 3, the first chamber 50′ may be generally rectangular in shape nearest the throat 20′ and trapezoidal in shape nearest the opening 55′.

Returning to FIG. 1, the first chamber 50 may be connected or coupled to the second chamber 60 at an angle ranging about from 0° to 180°. At the location of connection between the first chamber 50 and second chamber 60 an opening 55 is present to allow sound waves to pass from the first chamber 50 to the second chamber 60.

The first chamber 50 has a cross-sectional area that increases linearly from approximately the location of the throat 20 to approximately the location of the opening 55. As can best be viewed in FIG. 1, the linear increase in cross-sectional area in the first chamber may be accomplished by angling one or more wall sections of the first chamber 50. For example, angled baffles 222 and 225 may be positioned so that each forms an opposing wall of the first chamber 50 and the two walls are angled so that the distance between them increases in the direction from the throat 20 to the opening 55. Furthermore, in the preferred embodiment the back panel 270 and the internal baffle 275 may be, but need not be, approximately parallel to one another.

While in the embodiment shown in FIG. 1, two baffles are used to increase the cross-sectional area linearly from a location approximately near the throat 20 to the opening 55, it is apparent to one of ordinary skill in the art that a single baffle could also achieve the same result. Furthermore, more than two walls of the first chamber 50 could be angled to achieve the linear increase in cross-sectional area. For example, in FIG. 3, four walls of the first chamber 50′ are angled. In this embodiment, the inclined baffle 475 and the bottom panel 430 are positioned so that each forms a wall of the first chamber 50′ and the two walls are angled so that the distance between them increases from the throat 20′ to the opening 55′. However, the angled side baffle 422 and the angled side baffle 425 are positioned so that each forms a wall of the first chamber 50′ and the two walls are angled so that the distance between them decreases from the throat 20′ to the opening 55′. The rate of decrease in distance between the angled side baffle 422 and the angled side baffle 425, however, is less than the rate of increase in distance between the inclined baffle 475 and the bottom panel 430. Therefore, the cross-sectional area of the first chamber 50′ increases linearly from the approximate location of the throat 20′ to the opening 55′.

Returning to FIG. 1, the second chamber 60 has a cross-sectional area that increases substantially linearly from approximately the location of the opening 55 to approximately the location of the mouth 40. In both of the embodiments illustrated, this may be accomplished in a similar manner. Referring to FIG. 1, both the left exterior side panel 240 and the right exterior side panel 250 are angled along at least one edge. The angled edge is connected to either the top panel 220 or the bottom panel 230. Furthermore, in the embodiment illustrated, the side panels may be angled along both the edge that connects to the top panel 220 and the edge that connects to the bottom panel 230. Constructing the side panels in this manner may cause the distance between the top panel 220 and the bottom panel 230 to increase from the back panel 270 to the front 260. In both FIGS. 1 and 3, the top panel 220 and the bottom panel 230 form opposing walls of the second chamber 60 that traverse a portion of the second chamber 60 between the opening 55 and the mouth 40. Furthermore, the left exterior side panel 240 and the left internal baffle 244 form opposing walls of the second chamber 60 that traverse a portion of the second chamber 60 between the opening 55 and the mouth 40. The left exterior side panel 240 and the left internal baffle 244 may be approximately parallel to one another. Therefore, in the preferred embodiment, the rate of linear increase in the second chamber 60 may be determined by the angle of one or more edges of the left and right exterior side panels, 240 and 250 respectively.

However, it is apparent to one of ordinary skill in the art that the edges of the right and left exterior side panels need not be angled to achieve a linear increase in cross-sectional area from the opening 55 to the mouth 40 in the second chamber 60. One or more internal baffles similar to those included in the first chamber 50 could be positioned to determine the cross-sectional area of the second chamber 60. If, for example, it is desirable for the top panel 220 and the bottom panel 230 to be parallel so that two or more horns may be easily stacked, internal baffles could be placed along the top panel 220 and/or the bottom panel 230 to form walls of the second chamber 60. One or more of these internal baffles could be angled so that the distance between them increases from the opening 55 to the mouth 40. Alternatively, the left internal baffle 244 could be angled so that the distance between it and the left exterior side panel 240 increases from the opening 55 to the mouth 40. It may also be possible to angle the edges of the top panel 220 and the bottom panel 230 that connect to the side panels. In this manner, the distance between the left exterior side panel 240 and the right exterior side panel 250 could increase from a point near the opening 55 to a point near the mouth 40.

In a preferred embodiment, the rate of cross-sectional area linear increase of the first chamber 50 is greater than the rate of cross-sectional area linear increase of the second chamber 60.

While the series of chambers in the preferred embodiment of the low frequency horn 10 contains two chambers, it is apparent to one of ordinary skill in the art that low frequency horn 10 may include additional chambers. These additional chambers may be located between the first 50 and second 60 chambers. Each of these additional chambers may have a cross-sectional area that increases linearly from the location of the connection between a particular chamber and the chamber that precedes it in the series to the location of the connection between a particular chamber and the chamber that succeeds it in the series. At the locations of connections between chambers, openings are present to allow sound waves to travel between the chambers. These additional chambers may be connected at angles ranging between 0° to 180° to other chambers in the series.

When a low frequency horn constructed in accordance with the claimed invention is used to amplify low frequency sound waves, it is preferable to include more than one horn. As can be viewed in FIG. 1, preferably, a single loudspeaker will contain at least one pair of low frequency horns 203 and 205. Furthermore, it is also preferable to include several loudspeakers for the purposes of amplifying low frequency sound waves. In the preferred embodiment, between two and forty, and preferably, four loudspeakers are used. Further, it is preferable to locate these loudspeakers in close proximity with one another. Therefore, in the preferred embodiment the loudspeakers are positioned approximately immediately adjacent to one another.

Loudspeaker

FIGS. 1 and 3-6 illustrate loudspeakers constructed to include low frequency horns 10. While the loudspeakers in FIGS. 1 and 3 and 6 are provided to illustrate embodiments of the present invention, it is apparent to one of ordinary skill in the art that alternate loudspeaker designs may be developed to include the present invention and are therefore within the scope of the present invention.

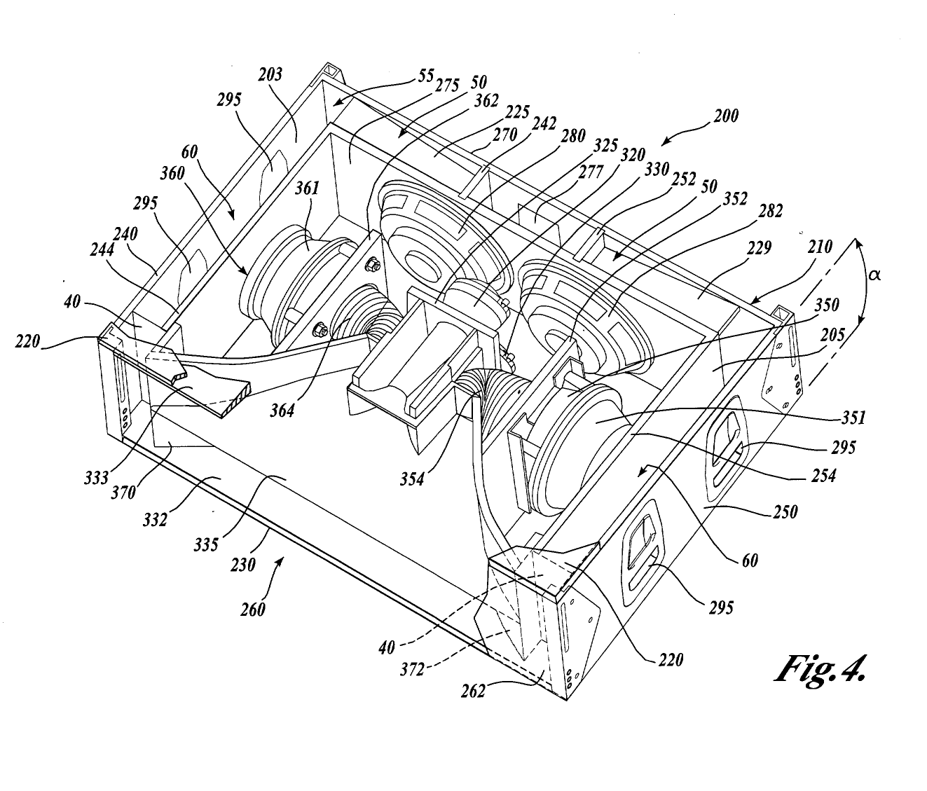

The loudspeaker 200 in FIG. 4 will now be described in detail. In this embodiment, the loudspeaker 200 contains two low frequency horns 203 and 205 constructed in accordance with the present invention. The internal structure of low frequency horns 203 and 205 contained in loudspeaker 200 can also be viewed in FIG. 1. Structurally, the low frequency horns 203 and 205 are essentially identical mirror images of one another. Both low frequency horns are contained in the housing 210 of the loudspeaker 200. As is best viewed in FIG. 4, the housing 210 may be formed by the top panel 220, bottom panel 230, back panel 270, left-exterior side panel 240, and right exterior side panel 250.

The top panel 220 and bottom panel 230 may be generally rectangular in shape and approximately equal in size. In the preferred embodiment, the length of the top panel 220 and bottom panel 230 may be between about 15 and 60 inches, and is preferably about 42 inches, the width of the top panel 220 and bottom panel 230 may be between 12 and 60 inches, and is preferably about 30 inches, and the top panel 220 and bottom panel 230 panels may be between about 0.5 and 3 inches thick.

The right side panel 250 and left side panel 240 may be approximately equal in size. The side panels 240 and 250 have two parallel edges, one of which connects to the back panel 270. The side panels 240 and 250 may also have one or more angled top and/or bottom edges that connect to the top panel 220 and/or the bottom panel 230, thereby defining the side panels in a rearwardly tapered profile when viewing the housing 210 from the side of the loudspeaker 200. In a preferred embodiment, both the edge that connects to the top panel 220 and the edge that connects to the bottom panel 230 are angled. In the preferred embodiment, the angle or taper α of the sides may be between about 0° and 15°, and is preferably about 3°. In the preferred embodiment, the length of the right side panel 250 and left side panel 240 may be between about 12 and 60 inches, and is preferably about 30 inches, the height of the right exterior side panel 250 and left exterior side panel 240 along the end edge nearest to the front may be between about 6 and 24 inches, and is preferably about 13 inches, the height of the right side panel 250 and left side panel 240 along the end edge that connects to the back panel 270 may be between about 6 and 24 inches, and is preferably about 15 inches, and the right exterior side panel 250 and left exterior side panel 240 panels may be between about 0.5 and 3 inches thick.

The back panel 270 may be generally rectangular in shape. If one or more sides of the side panels 240 and 250 are tapered, the vertical distance between the top panel 220 and the bottom panel 230 at the front 260 will be greater than the height of the back panel 270. In the preferred embodiment, the distance between the right side panel 250 and the left side panel 240 at the front 260 and the length of the back panel 270 may be between 15 and 60 inches and is preferably about 42 inches, the vertical distance between the top panel 220 and the bottom panel 230 at the front 260 may be between about 6 and 24 inches, and is preferably about 15 inches, and the height of the back panel 270 may be between 6 and 24 inches, and is preferably about 13 inches. The back panel 270 may be between about 0.5 and 3 inches thick.

In the preferred embodiment, the top panel 220, bottom panel 230, back panel 270, right exterior side panel 250, and left exterior side panel 240 may be constructed from plywood, such as birch plywood or plywood having physical characteristics similar to birch.

The side panels 240 and 250 are attached to the bottom panel 230 and the top panel 220. As noted above, the sides are arranged so that the narrower portion (smaller elevation end) of a side is attached to the back panel 270. The back panel 270 is attached to the bottom panel 230 and top panel 220 opposite the front 260. The side exterior panels 240 and 250 are connected to opposite sides of the back panel 270 at approximately right angles.

The loudspeaker is generally rectangular in shape when viewed from the top and the front. However, when viewed from the side, a cross-section of the loudspeaker 200 is generally trapezoidal in shape.

In FIG. 4, the loudspeaker is viewed from above with a portion of the top panel 220 removed to expose the internal structure of loudspeaker 200. The left low frequency horn 203 is located nearer to the left side panel 240 and the right low frequency horn 205 is located nearer to the right side panel 250. In this embodiment, the first chamber 50 of the left low frequency horn 203 is formed as follows. A portion of the back panel 270 forms one of the walls of the first chamber 50. A section of an internal rear baffle 275 forms a wall of the first chamber 50 that is opposite the wall formed by the back panel 270. The internal baffle 275 may be approximately parallel to the back panel 270 and is attached along its edges to the top panel 220 and the bottom panel 230.

Referring to FIG. 1, diagonal baffles 222 and 225 are attached to the internal rear baffle 275 and the back panel 270. Diagonal baffles 222 and 225 form the remaining top and bottom walls of the first chamber 50 of the left low frequency horn 203. Upper diagonal baffle 225 is positioned so that it is nearest to the top 220 on its left most edge and lower diagonal baffle 222 is positioned so that it is nearest to the bottom 230 on its left most edge. The angled baffles 222 and 225 may be approximately equal in size.

A generally upright baffle 242 spans between the internal baffle 275 and the back panel 270. Baffle 242 is attached to the central most ends of the diagonal baffles 222 and 225. A section of baffle 242 forms a wall of the first chamber 50 of the left low frequency horn 203.

The first chamber 50 of the right low frequency horn 205 is formed as follows. A portion of the back panel 270 forms one of the walls of the first chamber 50. A section of an internal baffle 275 forms a wall of the first chamber 50 that is opposite the wall formed by the back 270. The internal baffle 275 may be approximately parallel to the back panel 270 and is attached along its edges to the top panel 220 and the bottom panel 230.

Attached to the internal baffle 275 and the back panel 270 are the angled top and bottom diagonal baffles 227 and 229. Diagonal baffles 227 and 229 form walls of the first chamber 50 of the right low frequency horn 205. Upper diagonal baffle 229 is positioned so that it is nearest to the top 220 on its right most edge and lower diagonal baffle 227 is positioned so that it is nearest to the bottom 230 on its right most edge. The diagonal baffles 227 and 229 are approximately equal in size.

Generally upright baffle 252 is attached to the internal baffle 275 and the back panel 270. Baffle 252 is attached to the central most ends of the diagonal baffles 227 and 229. A section of vertical baffle 252 forms a wall of the first chamber 50 of the right low frequency horn 205.

The throat 20 of the left low frequency horn 203 is located in the internal baffle 275 between the diagonal baffles 222 and 225 to the left of vertical baffle 242. The throat of the right low frequency horn 205 is located in the internal baffle 275 between the diagonal baffles 227 and 229 to the right of vertical baffle 252. Both throats are formed by apertures in the internal baffle 275. The source of the sound waves 280 and 282 for both low frequency horns are attached to the internal baffle 275 at their respective throats. As mentioned above, the preferred source of sound waves is a cone-type electroacoustic transducer. In this embodiment, the electroacoustic transducers 280 and 282 are positioned so that sound waves are projected toward the back panel 270.

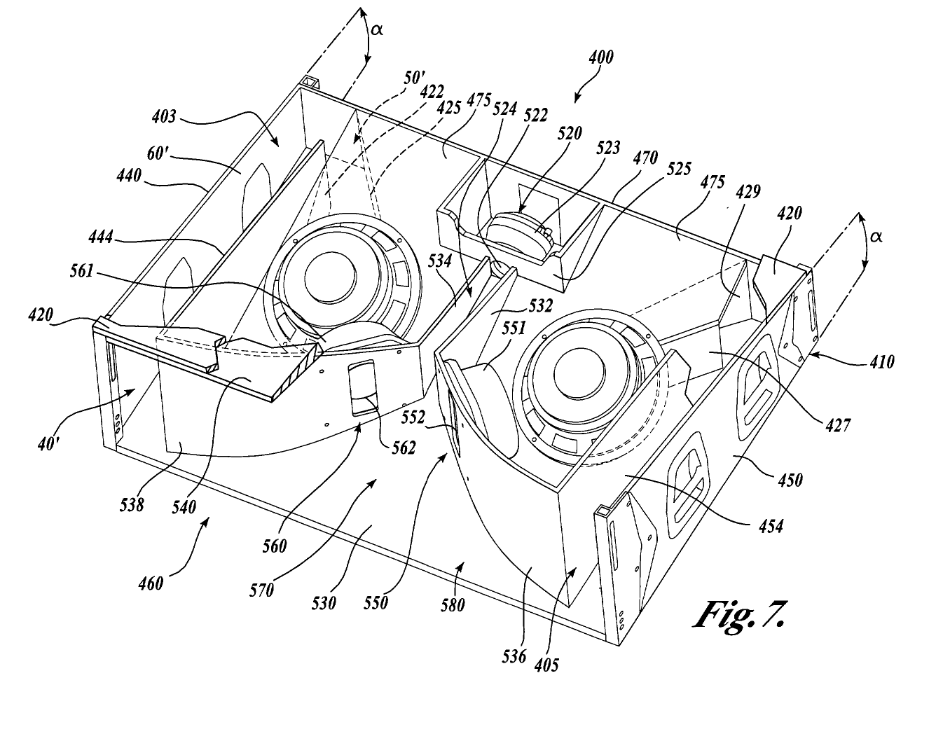

Referring to FIG. 4, it may be convenient to locate an internal handle 277 in the back panel 270 between vertical baffles 242 and 252. Handle 277 may be an aperture formed in the back panel 270 so that the back panel 270 defines the handle 277. Preferably, the aperture is suitably sized and shaped to receive one or more human fingers to facilitate lifting, moving and/or carrying the loudspeaker. In the embodiments shown in FIGS. 4 and 7, the handle 277 is generally rectangular in shape. However, it is apparent to one of ordinary skill in the art that other shapes such as square, round, oval, polygonal, trapezoidal, etc., are also within the scope of the present invention. Alternatively, a handle member (not shown) could be coupled to the outside surface of the back panel 270. In this manner, handle 277 may be formed by the handle member and the outside side surface of back panel 270. In yet another embodiment, handle 277 may include an inwardly extending depression formed on the outside surface of the back panel 270. Preferably, the depression is suitably sized to receive one or more fingers to facilitate lifting, moving, and/or carrying the loudspeaker.

The second chamber 60 of both the left low frequency horn 203 and the right low frequency horn 205 are defined by five walls. One wall of both low frequency horns 203 and 205 is formed by a section of the bottom panel 230. A portion of the top panel 220 forms the second wall of both low frequency horns 203 and 205. A third wall of both low frequency horns 203 and 205 is formed by a portion of the back panel 270 and is the back most section of the second chamber 60. A portion of the left exterior side panel 240 forms the fourth wall of the second chamber 60 of the left low frequency horn 203. A portion of the right exterior side panel 250 forms the fourth wall of the second chamber 60 of the right low frequency horn 205. The remaining wall of left low frequency horn 203 is formed by a section of a left internal baffle 244. Left internal baffle 244 is attached to the top panel 220 and the bottom panel 230. Left internal baffle 244 may be approximately parallel with the left side panel 240. The remaining wall of right low frequency horn 205 is formed by a section of a right internal baffle 254. Right internal baffle 254 is attached to the top panel 220 and the bottom panel 230. Right internal baffle 254 may be approximately parallel with the right side panel 250.

In both low frequency horns 203 and 205, the first chamber 50 is connected to the second chamber 60 at approximately a right degree angle opening 55. Opening 55 allows sound waves to travel from the first chamber 50 to the second chamber 60 in both low frequency horns 203 and 205.

It may be beneficial to include inset handles 295 (shown in FIG. 4) on the right exterior side panel 250 and the left exterior side panel 240 to aid with transporting the loudspeaker 200.

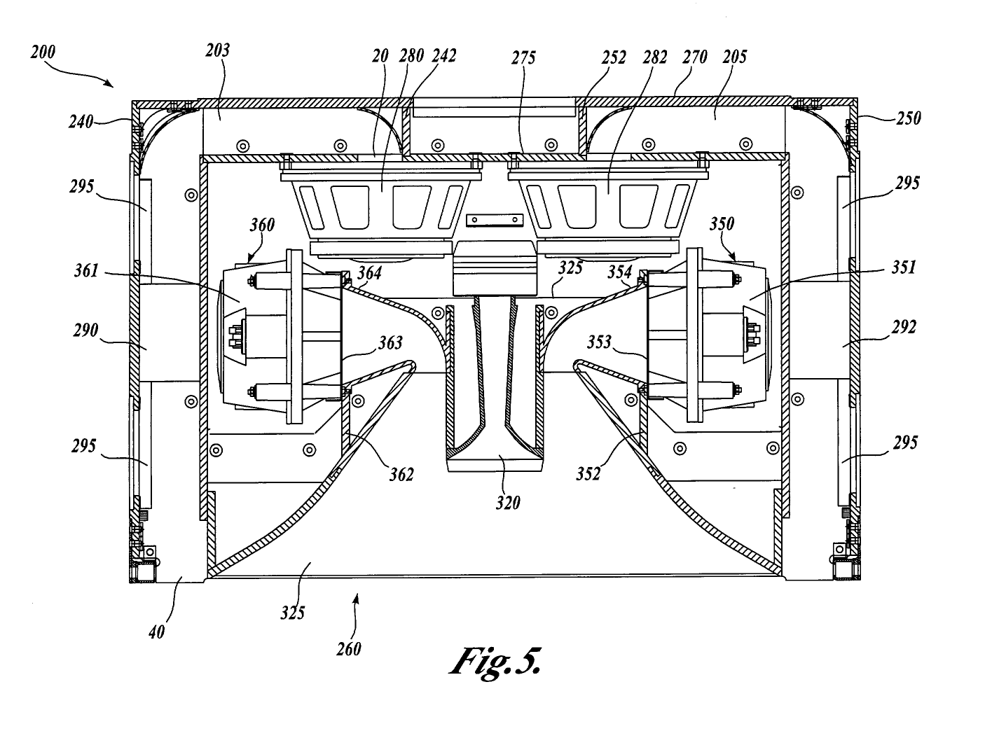

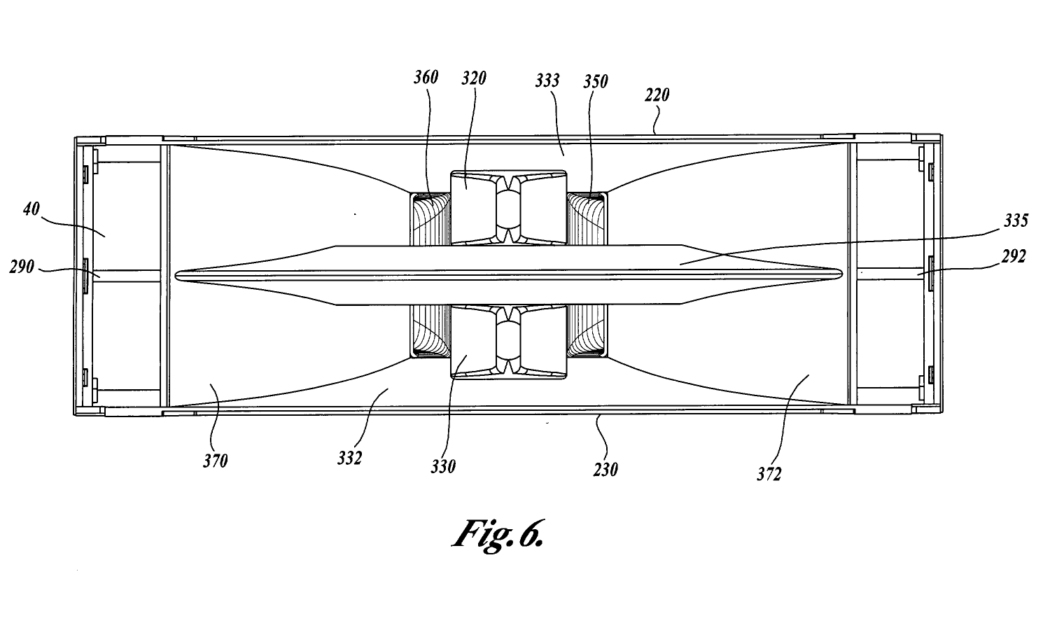

In a preferred embodiment, horizontal stiffeners 290 and 292 (shown in FIGS. 5 and 6) may be located within the second chamber of the low frequency horns 10 to provide increased strength and structural integrity. It may be beneficial to locate the horizontal stiffeners between the handles 295 as shown in FIG. 5.

The mouth 40 of both low frequency horns 203 and 205 is located at the distal end of second chamber 60. Furthermore, the mouths 40 of both the left low frequency horn 203 and right low frequency horn 205 may be located near the front 260 of the loudspeaker 200 so that sound waves exit the loudspeaker 200 from the front 260.

In the preferred embodiment, a grill plate 262 that allows sound to exit the loudspeaker may be located at the front 260. The grill plate 262 may be attached to one or more components of the housing 210. Non-limiting examples of suitable materials to form the grill plate include expanded or perforated plastic or metal.

Because the low frequency horns 203 and 205 occupy much of the space along the right, left, and back sides of the housing, the midrange and high frequency horns are located more centrally within the loudspeaker 200. While many configurations of the midrange and high frequency horns are available one will be presented here for illustrative purposes. It is, however, apparent to one of ordinary skill in the art that alternate arrangements and configurations of the midrange and high frequency horns are within the scope of the present invention.

Like low frequency horns, both the midrange and high frequency horns also contain three main components, throat, barrel, and mouth.

Referring to FIG. 4, the loudspeaker 200 contains a pair of high frequency horns 320 and 330 located approximately centrally between the left side panel 240 and the right side panel 250. The high frequency horns 320, 330 may be attached to a vertical baffle 325 and may be arranged or stacked vertically so that the top high frequency horn 320 is nearest the top panel 220 and the bottom high frequency horn 330 is nearest the bottom panel 230. The throat, barrel, and mouth of the high frequency horns may be arranged in a linear configuration so that the sound waves need not travel around any corners.

A horizontal baffle 335 divides the high frequency horns 320 and 330 from a point in the barrel of each horn to the front 260 of the loudspeaker 200. Preferably, the horizontal baffle 335 divides the high frequency horns 320 and 330 at the portion of the barrel immediately following the throat.

The loudspeaker 200 also contains a pair of midrange horns 350, 360. The right midrange horn 350 may be located between the high frequency horns 320 and 330 and the right side panel 250. The left midrange horn 360 may be located between the high frequency horns 320 and 330 and the left side panel 240. The sources of midrange sound waves 351 and 361 for the midrange horns 350 and 360 respectively may be connected to vertical baffles 352 and 362 respectively. Apertures 353 and 363 (shown in FIG. 5) in the vertical baffles 352 and 362 form the throats of the right and left midrange horns 350 and 360 respectively. The vertical baffles 352 and 362 may be connected to barrel sections 354 and 364 respectively so that the barrel sections 354 and 364 are adjacent to the throats (see FIG. 5) in the vertical baffles 352 and 362. Preferably, barrel sections 354 and 364 are constructed from a hollow flexible material that allows sound waves to travel though it. Suitable materials include plastics such as molded polyurethane.

Preferably, the horizontal baffle 335 extends from the high frequency horns to the front 260 and is bordered on either side by curved vertical baffles 370 and 372. Curved vertical baffles 370 and 372 are attached to a top baffle 333 and a bottom baffle 332. Preferably, vertical baffles 370 and 372 curve or flare laterally in the forward direction so that the cross-sectional area formed between them increases exponentially from the location of the high frequency horns in the forward direction to the forward edges of the curved vertical baffles 370 and 372 at the front 260 of loudspeaker 200. It is also preferable that the top baffle 333 and the bottom baffle 332 are sloped so that the distance between them increases from a point near the high frequency horns 320 and 330 to a point closer to the front 260. In this regard, the heights of the vertical baffles 370 and 372 increase in the direction toward the front 260 of the loudspeaker 200.

In the preferred embodiment, the horizontal baffle 335 that horizontally divides the high frequency horns 320 and 330 extends horizontally to both the left and right of the high frequency horns. The portion of the horizontal baffle 335 to the right of the high frequency horns may be coupled to the barrel section 354 of the right midrange horn 350, and the portion of the horizontal baffle 335 to the left of the high frequency horns may be coupled to the barrel sections 364 of the left midrange horn 360. This connection bifurcates the barrel of each midrange horn. In the preferred embodiment, the midrange horns share two barrel sections. The first barrel section is formed between the horizontal baffle 335, the top baffle 333, curved vertical baffle 370, and curved vertical baffle 372. The second barrel section is formed between the horizontal baffle 335, the bottom baffle 332, curved vertical baffle 370, and curved vertical baffle 372. Connecting barrel sections 354 and 364 of the midrange horns to the horizontal baffle 335 allows the midrange horns and the high frequency horns to share a common mouth in the front 260 of the loudspeaker 200.

In FIG. 7, loudspeaker 200 is shown from the front 260 to illustrate the bifurcation of both the right and left midrange horns and the common mouth used by both high frequency horns and both midrange horns.

Further Loudspeaker Embodiment

The loudspeaker 400 in FIG. 7 will now be described in detail. In this embodiment, the loudspeaker 400 contains two low frequency horns 403 and 405 constructed in accordance with the present invention. The low frequency horns 403 and 405 contained in loudspeaker 400 may also be viewed in FIG. 3. Structurally, the low frequency horns 403 and 405 are essentially identical mirror images of one another. Both low frequency horns 403 and 405 are contained in the housing 410 of the loudspeaker 400. As is best viewed in FIG. 7, the housing 410 of the loudspeaker 400 includes the top panel 420, bottom panel 430 (see FIG. 3), back panel 470, right exterior side panel 450, and left exterior side panel 440. The housing 410 of the loudspeaker 400 is similar in contribution to the housing 210 of the loudspeaker 200. Consequently, the housing 410 of the loudspeaker 400 will not be discussed in greater detail.

In FIG. 7, the loudspeaker 400 is viewed from the top with a majority portion of the top panel 420 removed to expose the internal structure of loudspeaker 400. The left low frequency horn 403 is located nearer to the left side panel 440 and the right low frequency horn 405 is located nearer to the right side panel 450.

As can be best viewed in FIG. 3, the first chamber 50′ of the left low frequency horn 403 is formed between the inclined baffle 475, bottom panel 430, vertical baffle 442, angled baffle 422, and angled baffle 425. Inclined baffle 475 may be connected to the back panel 470 near to the top panel 420 and slopes downward toward the front 460. The throat 20′ may be located in inclined baffle 475. The source of the sound waves is attached to the inclined baffle 475 on the surface nearest the top panel 420. Angled baffle 422, angled baffle 425, and vertical baffle 442 may be connected between the inclined baffle 475 and the bottom panel 430. Angled baffle 422 may be connected to the vertical baffle 442 and the internal baffle 444. Angled baffle 425 may be connected to the vertical baffle 442 and the back panel 470.

The first chamber 50′ of the right low frequency horn 405 may be formed between sections of the inclined baffle 475, bottom panel 430 (see FIG. 3), a vertical baffle (not shown but similar to vertical baffle 442), angled baffle 427, and angled baffle 429. The throat (not shown but similar to the throat 20′ of the left low frequency horn 403) may be located in inclined baffle 475. The source of the sound waves may be attached to the inclined baffle 475 on the surface nearest the top panel 420. Angled baffle 427, angled baffle 429, and the vertical baffle (not shown but similar to vertical baffle 442) are connected between the inclined baffle 475 and the bottom panel 430. Angled baffle 427 is connected to the vertical baffle and the internal baffle 454. Angled baffle 429 is connected to the vertical baffle and the back panel 470.

Alternately, the first chamber 50′ of both low frequency horns may be tunnels formed in a solid section that occupies the space between the top surface of inclined baffle 475 and the bottom panel 430. In this alternate embodiment (not shown), the internal surfaces within the solid section form most of the walls of the first chamber 50′. A section of the bottom panel 430 could form the remaining wall of the first chamber. It is also possible for the entire first chamber 50′ to be contained within the solid section so that no portion of the bottom panel 430 is required to form a wall of the first chamber 50′.

The second chamber 60′ of both the left low frequency horn 403 and the right low frequency horn 405 of loudspeaker 400 are constructed similarly to the second chamber 60 of the left low frequency horn 203 and the right low frequency horn 205 of loudspeaker 200. The second chamber 60′ of both the left low frequency horn 403 and the right low frequency horn 405 are formed from five walls. A section of the bottom panel 430 forms one wall of both low frequency horns 403 and 405. A second wall of both low frequency horns 403 and 405 is formed by a section of the top panel 420. The third wall of both low frequency horns 403 and 405 is formed by a portion of the back panel 470 and is the back most section of the second chamber 60′. The fourth wall of the second chamber 60′ of the left low frequency horn 403 is formed by a section of the left exterior side panel 440. The fourth wall of the second chamber 60′ of the right low frequency horn 405 is formed by a section of the right exterior side panel 450. The remaining wall of left low frequency horn 403 is formed by a section of the left internal baffle 444. Left internal baffle 444 spans between the top panel 420 and the bottom panel 430. Left internal baffle 444 may be approximately parallel with the left side panel 440. Right internal baffle 454 forms the remaining wall of right low frequency horn 405. Right internal baffle 454 spans between the top panel 420 and the bottom panel 430. Right internal baffle 454 may be approximately parallel with the right side panel 450.

In both low frequency horns 403 and 405, the first chamber 50′ is connected to the second chamber 60′ at approximately a 160 degree angle. Opening 55′ allows sound waves to travel from the first chamber 50′ to the second chamber 60′ in both low frequency horns 403 and 405.

Loudspeaker 400 contains a single high frequency horn 520. The throat 522 of the high frequency horn 520 is located in a vertical baffle 525. Vertical baffle 525 spans between the top panel 420 and the bottom panel 430. The source of high frequency sound waves 523 is located adjacent to the throat 522 of the high frequency horn 520 and is connected to the rearward surface of the vertical baffle 525.

The barrel 524 of the high frequency horn 520 includes two chambers. The first chamber is formed between the vertical baffle 532, vertical baffle 534, bottom baffle 530 and top baffle 540. Vertical baffles 532 and 534 are approximately parallel and connected to the top baffle 540, bottom baffle 530 and the vertical baffle 525. Both the top baffle 540 and the bottom baffle 530 are angled or curved so that the distance between them increases as sound waves move toward the front 460.

The second chamber 570 of the barrel 524 of the high frequency horn 520 is formed between a right curved baffle 536, left curved baffle 538, bottom baffle 530 and top baffle 540. Right curved baffle 536 is connected to the forward edge of the vertical baffle 532, the forward edge of the right internal baffle 454, the bottom baffle 530, and the top baffle 540. Left curved baffle 538 is connected to the forward edge of the vertical baffle 534, the forward edge of the left internal baffle 444, the bottom baffle 530, and the top baffle 540. Both baffle 536 and curved baffle 538 are curved so that the distance between them increases exponentially as the sound waves travel from the location of the connection of curved baffles 536 and 538 to the first chamber of the high frequency horn 520 to a location near the front 460.

Loudspeaker 400 contains a pair of midrange horns 550 and 560. In the illustrated embodiment, the barrel of the midrange horns contains a single chamber. In this embodiment, both midrange horns may also share a common barrel chamber. This chamber may be the same chamber utilized by the high frequency horn 520 as its second chamber 570. Consequently, the midrange horns 550 and 560 and the high frequency horn 520 may share a common mouth 580.

However, because the throats 552 and 562 of the midrange horns are located in a position that is closer to the front 460 than the opening between the first and second chambers of the high frequency horn 520, the midrange horns may utilize a smaller portion of the chamber 570 than the high frequency horn 520.

Each midrange horn 550 and 560 includes a source of midrange frequency sound waves 551 and 561 respectively. The sources of midrange frequency sound waves 551 and 561 are attached to the curved baffles 536 and 538 respectively. The sources of midrange frequency sound waves 551 and 561 may be located on the surface opposite to the surface forming a wall of the second chamber 570 of the high frequency horn 520. Adjacent to the location of the source of midrange frequency sound waves, apertures 552 and 562 are located in the curved baffles 536 and 538 respectively. Apertures 552 and 562 are the throats of the midrange horns 550 and 560, respectively.

While several embodiments of the invention have been illustrated and described, it will be appreciated that various changes can be made to these embodiments without departing from the spirit and scope of the invention.

The embodiments of the invention in which an exclusive property or privilege is claimed are defined as follows:

1. A low frequency horn apparatus comprising:
a plurality of chambers arranged in a series wherein
each chamber has a first end with a first aperture and second end with a second aperture;
the cross-sectional area of each chamber increases linearly from the first end to the second end;
each chamber in the series after the first chamber is coupled at its first end to the second end of the chamber immediately preceding it in the series so that the aperture in the first end of each chamber after the first chamber is adjacent to the second aperture in the second end of the chamber immediately preceding it in the series; and
wherein sound waves enter the first end of the first chamber in the series and exit the second end of the last chamber in the series and the rate of linear increase in cross-sectional area is greatest in the first chamber in the series.

2. The low frequency horn apparatus in claim 1, wherein the sound waves are generated by an electroacoustic transducer.

3. The low frequency horn apparatus in claim 2, wherein the electroacoustic transducer comprises a cone.

4. The low frequency horn apparatus in claim 3, wherein the cross-sectional area of the cone is greater than the cross-sectional area of the aperture in the second end of the last chamber in the series.

5. The low frequency horn apparatus in claim 1, wherein the intersection between any two coupled chambers in the series of chambers forms an angle between 0° and 180°.

6. The low frequency horn apparatus in claim 1 wherein the rate of linear increase in cross-sectional area of each chamber following the first chamber in the series is less than the rate of linear increase in cross-sectional area of the preceding chamber in the series.

7. The low frequency horn apparatus in claim 1, wherein the sound waves have a frequency between 30 and 200 Hz.

8. A low frequency horn apparatus comprising:
a first chamber with a first end having a throat aperture and a second end having a mouth aperture wherein the cross-sectional area of the first chamber increases linearly from the first end to the second end of the first chamber;
a second chamber with a first end having a throat aperture and a second end having a mouth aperture wherein the cross-sectional area of the second chamber increases linearly from the first end to the second end of the second chamber;
wherein the second chamber is coupled at its first end to the second end of the first chamber so that the mouth aperture of the first chamber is adjacent to the throat aperture of the second chamber;
a source of sound waves directs sound waves into the throat aperture of the first chamber; and
the rate of linear increase in cross-sectional area is greater in the first chamber than in the second chamber.

9. The low frequency horn apparatus in claim 8, wherein the sound waves have a frequency between 30 and 200 Hz.

10. The low frequency horn apparatus in claim 8, wherein the source of sound waves comprises an electroacoustic transducer.

11. The low frequency horn apparatus in claim 10, wherein the electroacoustic transducer comprises a cone.

12. The low frequency horn apparatus in claim 11, wherein the cross-sectional area of the cone is greater than the cross-sectional area of the mouth aperture of the second chamber.

13. A folded horn apparatus comprising:
a first chamber with a first end having a throat aperture and a second end having a mouth aperture;
a second chamber with a first end having a throat aperture and a second end having a mouth aperture; and
an electroacoustic transducer comprising a cone directing sound waves into the throat aperture of the first chamber;
wherein the second chamber is coupled at its first end to the second end of the first chamber so that the mouth aperture of the first chamber is adjacent to the throat aperture of the second chamber; and
the cross-sectional area of the cone is greater than the cross-sectional area of the mouth aperture of the second chamber.

14. The folded horn apparatus of claim 13, wherein the cross-sectional area of the first chamber increases linearly from the first end to the second end of the first chamber and the cross-sectional area of the second chamber increases linearly from the first end to the second end of the second chamber.

15. The folded horn apparatus of claim 14 wherein the rate of linear increase in cross-sectional area is greater in the first than in the second chamber.

16. The folded horn apparatus in claim 13, wherein the intersection of the first chamber and the second chamber forms an angle between 0° and 180°.

17. The folded horn apparatus in claim 13, wherein the sound waves have a frequency between 30 and 200 Hz.

18. A loudspeaker apparatus comprising
a speaker housing;
a pair of low frequency horn apparatuses located inside the speaker housing wherein each low frequency horn apparatus comprises;
a first chamber comprising a first end having a throat aperture and a second end having a mouth aperture wherein the cross-sectional area of the first chamber increases linearly from the first end to the second end of the first chamber; and
at least one subsequent chamber arranged in series with the first chamber, each subsequent chamber comprising a first end having a throat aperture and a second end having a mouth aperture wherein the cross-sectional area of the subsequent chamber increases linearly from the first end to the second end of the subsequent chamber at a rate of increase that is less than the rate of linear increase from the first end to the second end of the first chamber;
wherein each subsequent chamber is coupled at its first end to the second end of the chamber immediately preceding it in the series so that the mouth aperture of the chamber immediately preceding it in the series is in communication with the throat aperture of the subsequent chamber;
a source of sound waves directs sound waves into the throat aperture of the first chamber wherein the source of sound waves is coupled to the speaker housing by at least one baffle;
at least one midrange horn located inside the speaker housing wherein each midrange horn has a source of sound waves that is coupled to the speaker housing by at least one baffle; and
at least one high frequency horn located inside the speaker housing wherein each high frequency has a source of sound waves that is coupled to the speaker housing by at least one baffle.

19. The loudspeaker apparatus in claim 18, wherein the speaker housing has a right and left side and at least one subsequent chamber of one low frequency horn apparatus is located along the left side of the housing and at least one subsequent chamber of the other low frequency horn apparatus is located along the right side of the housing.

20. The loudspeaker apparatus in claim 19, wherein the speaker housing has a back side and the first chambers of both low frequency horn apparatuses are located along the back side of the housing.

21. The loudspeaker apparatus in claim 18, wherein the speaker housing has a back side and the first chambers of both low frequency horn apparatuses are located along the back side of the housing.

22. The loudspeaker apparatus in claim 18, wherein each midrange horn is located between at least one subsequent chamber of one low frequency horn apparatus and at least one subsequent chamber of the other low frequency horn apparatus.

23. The loudspeaker apparatus in claim 18, wherein the speaker housing has a front side and the mouth apertures of both low frequency horn apparatuses are located on the front side of the speaker housing and each midrange horn has a mouth aperture located on the front side of the speaker housing.

24. The loudspeaker apparatus in claim 18, wherein each high frequency horn is located between at least one subsequent chamber of one low frequency horn apparatus and at least one subsequent chamber of the other low frequency horn apparatus.

25. The loudspeaker apparatus in claim 24, wherein the speaker housing has a front side and the mouth aperture of both low frequency horn apparatuses are located on the front side of the speaker housing and each high frequency horn has a mouth aperture located on the front side of the speaker housing.

26. The loudspeaker apparatus in claim 18, wherein the speaker housing has a front side and the mouth apertures of both low frequency horn apparatuses are located on the front side of the speaker housing and each high frequency horn has a mouth aperture located on the front side of the speaker housing and each midrange horn has a mouth aperture located on the front side of the speaker housing.

27. The loudspeaker apparatus in claim 26, wherein each midrange horn and each high frequency horn share a common mouth aperture.

28. A loudspeaker apparatus comprising
A. a speaker housing;
B. a pair of folded horn apparatuses located inside the speaker housing wherein each folded horn apparatus comprises;
1) a first chamber with a first end having a throat aperture and a second end having a mouth aperture;
2) a second chamber with a first end having a throat aperture and a second end having a mouth aperture comprising a cross-sectional area; and
3) an electroacoustic transducer comprising a cone with a cross-sectional area directing sound waves into the throat aperture of the first chamber;
4) wherein the second chamber is coupled at its first end to the second end of the first chamber so that the mouth aperture of the first chamber is adjacent to the throat aperture of the second chamber; and
5) the electroacoustic transducer is coupled to the speaker housing by at least one baffle and the cross-sectional area of the cone is greater than the cross-sectional area of the mouth aperture of the second chamber; and
C. at least one midrange horn located inside the speaker housing comprising a source of sound waves coupled to the speaker housing by at least one baffle; and
D. at least one high frequency horn located inside the speaker housing comprising source of sound waves coupled to the speaker housing by at least one baffle.

29. The loudspeaker apparatus in claim 28, wherein the speaker housing has a right and left side and the second chamber of one folded horn apparatus is located along the left side of the housing and the second chamber of the other folded horn apparatus is located along the right side of the housing;

30. The loudspeaker apparatus in claim 28, wherein the speaker housing has a back side the first chambers of both folded horn apparatuses are located along the back side of the housing.

31. The loudspeaker apparatus in claim 28, wherein each midrange horn is located between the second chamber of one folded horn apparatus and the second chamber of the other folded horn apparatus.

32. The loudspeaker apparatus in claim 31, wherein the speaker housing has a front side and the mouth apertures of both folded horn apparatuses are located on the front side of the speaker housing and each midrange horn has a mouth aperture located on the front side of the speaker housing.

33. The loudspeaker apparatus in claim 28, wherein each high frequency horn is located between the second chamber of one folded horn apparatus and the second chamber of the other low frequency horn apparatus.

34. The loudspeaker apparatus in claim 33, wherein the speaker housing has a front side and the mouth apertures of both folded horn apparatuses are located on the front side of the speaker housing and each high frequency horn has a mouth aperture located on the front side of the speaker housing.

35. The loudspeaker apparatus in claim 28, wherein the speaker housing has a front side and the mouth apertures of both folded horn apparatuses are located on the front side of the speaker housing and each high frequency horn has a mouth aperture located on the front side of the speaker housing and each midrange horn has a mouth aperture located on the front side of the speaker housing.

36. The loudspeaker apparatus in claim 35, wherein each midrange horn and each high frequency horn share a common mouth aperture.
